(19) United States
(12) Patent Application Publication
(10) Pub. No.: US 2025/0379513 A1
(43) Pub. Date: Dec. 11, 2025

(54) METHOD FOR OPERATING A POWER CONVERTER AND POWER CONVERTER

(71) Applicant: Infineon Technologies Austria AG, Villach (AT)

(72) Inventors: Alex PACINI, Villach (AT); Matthias Joachim KASPER, Villach (AT)

(21) Appl. No.: 19/222,440

(22) Filed: May 29, 2025

(30) Foreign Application Priority Data
Jun. 7, 2024 (DE) 102024116035.7

(51) Int. Cl. H02M 1/42; H02M 5/293

(52) U.S. Cl. CPC H02M 1/4208; H02M 5/293

(57) ABSTRACT

A method for operating a power converter and a power converter are disclosed. The method includes generating an alternating voltage (Vmn) based on three alternating input voltages (Va, Vb, Vc) received at an input (a, b, c) of a power converter. Generating the alternating voltage (Vmn) includes: generating the alternating voltage (Vmn) in an unregulated fashion by a switching circuit (1) comprising a three-phase half-bridge, controlling a waveform of the alternating voltage (Vmn) dependent on signal levels of the input voltages (Va, Vb, Vc), and controlling a power factor of power received at the input (a, b, c).

### RELATED APPLICATIONS

This application claims priority to earlier filed German Patent Application Serial Number 102024116035.7, filed on June 7, the entire teachings of which are incorporated herein by this reference.

### BACKGROUND

Three-phase PFC power converters, which may also be referred to as PFC power rectifiers, are widely used in various kinds of power conversion applications. Examples of such applications include on-board chargers (OBC) for charging a battery of a vehicle, or power supplies for lighting, telecommunication, or computer server applications. A three-phase PFC rectifier is configured to generate a rectified output voltage based on three alternating input voltages each received at a respective input. Furthermore, in order to control a power factor, a three-phase PFC rectifier is configured to control current waveforms of input currents received at the inputs such that, for example, the input currents have the same waveform as the input voltages.

### BRIEF DESCRIPTION

The input voltages received at the inputs are grid voltages received from a power grid, for example. In many cases it is desirable to provide a galvanic isolation between the inputs where the alternating input voltages are received and an output where the rectified output voltage is provided. A conventional three-phase PFC rectifier providing galvanic isolation between the input and the output may include two stages, a first stage configured to generate a rectified voltage (often referred to as a DC link voltage) based on the alternating input voltages, and a second stage configured to generate an output voltage based on the DC link voltage and to provide for a galvanic isolation between the first stage and the output. In this conventional three-phase PFC rectifier, the first stage usually includes three inductors and a DC link capacitor, and the second stage usually includes a transformer, an output capacitor and, optionally, an inductor in addition to the transformer. The inductors and the DC link capacitor are bulky and heavy and may take up to 50% of an overall size of the PFC rectifier.

There is a need for a three-phase PFC converter that can be operated using a simplified control scheme.

One example relates to a method. The method includes generating an alternating voltage based on three alternating input voltages received at an input of a power converter. Generating the alternating voltage includes generating the alternating voltage in an unregulated fashion by a switching circuit including a three-phase half-bridge, controlling a waveform of the alternating voltage dependent on signal levels of the input voltages, and controlling a power factor of power received at the input.

Another example relates to a power converter. The power converter includes a switching circuit and a control circuit. The switching circuit includes a three-phase half-bridge, is configured to receive three alternating input voltages from an input of the power converter, and includes an output. The control circuit is configured to control operation of the switching circuit such that the switching circuit generates an alternating voltage based on the alternating input voltages in an unregulated fashion, controls a waveform of the alternating voltage dependent on signal levels of the input voltages, and controls a power factor of power received at the input.

### BRIEF DESCRIPTION OF THE DRAWINGS

Examples are explained below with reference to the drawings. The drawings serve to illustrate certain principles, so that only aspects necessary for understanding these principles are illustrated. The drawings are not to scale. In the drawings the same reference characters denote like features.

FIG. 1 illustrates one example of a three-phase power converter that includes a switching circuit configured to receive three input voltages, and a control circuit configured to control operation of the switching circuit;

FIG. 2 illustrates one example of a method for operating a power converter of the type illustrated in FIG. 1 to generate an alternating voltage based on the three input voltages;

FIG. 3 illustrates one example of a switching circuit that includes a three-phase half-bridge;

FIG. 4 illustrates another example of a switching circuit that includes a three-phase half-bridge;

FIGS. 5A-5B illustrates examples of bidirectionally blocking switches that include two unidirectionally blocking switches;

FIG. 6 illustrates one example of a bidirectionally blocking switch implemented as a HEMT (high electron-mobility transistor);

FIG. 7 illustrates one example of a power supply system configured to provide the three input voltages;

FIG. 8 illustrates signal waveforms of three sinusoidal input voltages over one period;

FIG. 9 illustrates one example of the method according to FIG. 1;

FIGS. 10A-10B illustrate signal diagrams of an alternating voltage generated in accordance with the method according to FIG. 9;

FIGS. 11A-11C FIGs show different operating state of the switching circuit in order to illustrate one example for generating the alternating voltage based on the input voltages using the switching circuit;

FIG. 12 shows a block diagram of the control circuit according to one example;

FIG. 13 shows one example of a time duration generator included in the control circuit according to FIG. 12;

FIG. 14 illustrates one example of a power converter of the type illustrated in FIG. 1 that further includes a rectifier circuit and an optional transmitter circuit;

FIG. 15 illustrates one example of the rectifier circuit;

FIG. 16 illustrates another example of the rectifier circuit;

FIG. 17 illustrates one example of the transmitter circuit;

FIG. 18 illustrates another example of the transmitter circuit;

FIG. 19 illustrates one example of an input filter;

FIG. 20 shows signal diagrams that illustrate operation of the power converter according to one example;

FIG. 21 shows signal diagrams of an output voltage and an output current of a power converter of the type illustrated in FIG. 14; and

FIG. 22A-22E illustrate a transition phase of the switching circuit between an on-state of an electronic switch and one half-bridge of the switching circuit and an on-state of an electronic switch in another half-bridge of the switching circuit.

In the following detailed description, reference is made to the accompanying drawings. The drawings form a part of the description and for the purpose of illustration show examples of how the invention may be used and implemented. It is to be understood that the features of the various embodiments described herein may be combined with each other, unless specifically noted otherwise.

### DETAILED DESCRIPTION

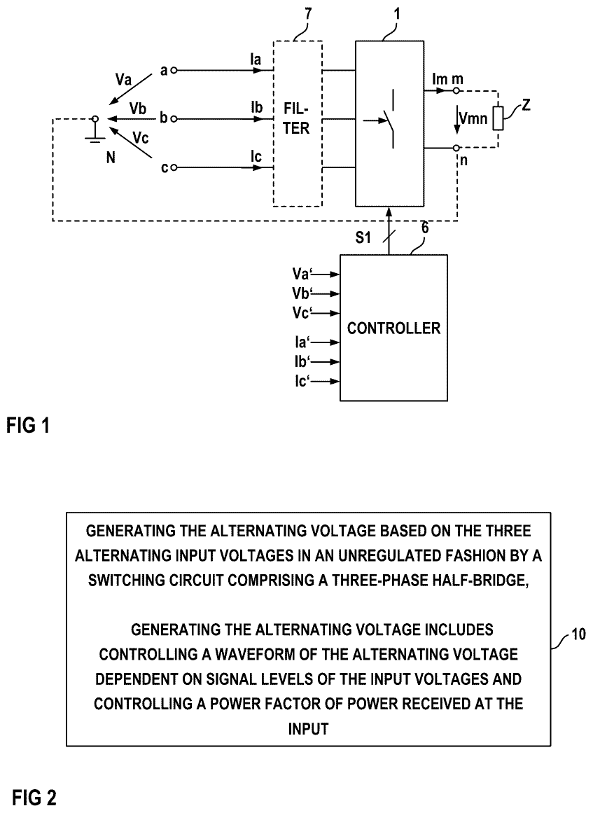

FIG. 1 illustrates one example of a power converter 1. The power converter includes an input a, b, c configured to receive three alternating input voltages Va, Vb, Vc and an output m, n configured to provide an alternating voltage Vmn based on the three alternating input voltages Va, Vb, Vc. The alternating input voltages Va, Vb, Vc are referenced to a common circuit node N, such as ground, for example.

The power converter includes a switching circuit 1 that includes a three-phase half-bridge and generates the alternating voltage Vmn based on the three input voltages Va, Vb, Vc. Examples of the switching circuit 1 are explained herein further below.

The power converter further includes a controller 6. The controller 6 is configured to control operation of the switching circuit 1 and is therefore configured to control generation of the alternating voltage Vmn and, in particular, to control a signal waveform of the alternating voltage Vmn.

FIG. 2 illustrates one example of a method 10 for operating the power converter according to FIG. 1. Referring to FIG. 2, the method 10 includes generating the alternating voltage Vmn based on the three alternating input voltages Va, Vb, Vc in an unregulated fashion by the switching circuit 2 that includes a three-phase half-bridge. Generating the alternating voltage Vmn includes controlling a waveform of the alternating voltage Vmn dependent on signal levels of the input voltage Va, Vb, Vc and controlling a power factor of power Pin received at the input a, b, c.

The power Pin received at the input of the power converter is given by the sum of the powers received at the individual inputs a, b, c, wherein the power received at each input a, b, c is given by the voltage Va, Vb, Vc received at the respective input a, b, c multiplied with the current Ia, Ib, Ic received at the respective input a, b, c,

$$Pin = Va \cdot Ia + Vb \cdot Ib + Vc \cdot Ic . \qquad ( 1 )$$

According to one example, it is desired to operate the power converter with a power factor of more than 90%, more than 95%, or even more than 99%. The power factor is 100% if the (alternating) current Ia, Ib, Ic received at each of the input a, b, c is exactly proportional to the respective input voltage Va, Vb, Vc and the same proportionality factor applies for the relationship between each of the input voltages Va, Vb, Vc and the corresponding input current Ia, Ib, Ic.

The input voltages Va, Vb, Vc are provided by a power source, such as a power grid, for example, and may have predefined waveforms. According to one example, the power source is a three-phase power grid that provides three sinusoidal input voltages Va, Vb, Vc.

In order to control generation of the alternating voltage Vmn by the switching circuit 1 and, at the same time, control the power factor, the control circuit 6 is configured to control operation of the switching circuit 1 based on measured input voltages Va′, Vb′, Vc′ and measured input currents Ia′, Ib′, Ic′. Each of the measured input voltages Va′, Vb′, Vc′ represents a respective one of the input voltages Va, Vb, Vc. According to one example, each of the measured input voltages Va′, Vb′, Vc′ is proportional to the respective input voltage Va, Vb, Vc. The measured input voltages Va′, Vb′, Vc′ may be generated based on the input voltages Va, Vb, Vc using conventional voltage sensors (not illustrated). Such voltage sensors are commonly known, so that no further explanation is required in this regard.

Each of the measured input currents Ia′, Ib′, Ic′ represents a respective one of the input currents Ia, Ib, Ic. According to one example, each of the measured input currents Ia′, Ib′, Ic′ is proportional to the respective input current Ia, Ib, Ic. The measured input currents Ia′, Ib′, Ic′ may be generated based on the input currents Ia, Ib, Ic using conventional current sensors (not illustrated). Such current sensors are commonly known, so that no further explanation is required in this regard.

Optionally, the power converter includes an input filter 7 connected between the input nodes a, b, c and the switching circuit 1. The filter 7 is configured to filter out high-frequency components of the input voltages Va, Vb, Vc and input currents Ia, Ib, Ic that may result from the switched-mode operation of the switching circuit 1. An example of the filter 7 is explained in detail herein further below. According to one example, the input voltages Va, Vb, Vc and input currents Ia, Ib, Ic are measured between the filter 7 and the switching circuit 1 in order to obtain the measured input voltages Va′, Vb′, Vc′ and measured input currents Ia′, Ib′, Ic′.

Referring to the above, the power converter generates the alternating voltage Vmn in unregulated fashion. This includes that the power converter, for controlling operation of the switching circuit 1, is devoid of any feedback circuit, so that the control circuit 6 controls operation of the switching circuit 1 only based on input parameters (input voltages Va, Vb, Vc and input currents Ia, Ib, Ic) of the power converter. Thus, the power converter does control the waveform of the alternating voltage Vmn, but does not regulate an amplitude or an RMS (root mean square) of the alternating output voltage Vmn. A power converter of the type illustrated in FIG. 1 may be referred to as half-bridge (HB) three-phase (3Φ) ACX (A: alternating C: current X: not regulated) converter, HB 3Φ ACX.

Referring to the above, the power converter according to FIG. 1 has a PFC functionality. Furthermore, the output voltage Vmn is an alternating voltage. This alternating voltage Vmn may be used in various ways. According to one example, illustrated in dashed lines in FIG. 1, the alternating voltage Vmn is directly received by a load Z. This, however, is only an example. According to further examples explained herein further below the alternating voltage Vmn is received by a converter stage that may include a galvanic isolation and be configured to generate a direct voltage based on the alternating output voltage Vmn of the switching circuit 1.

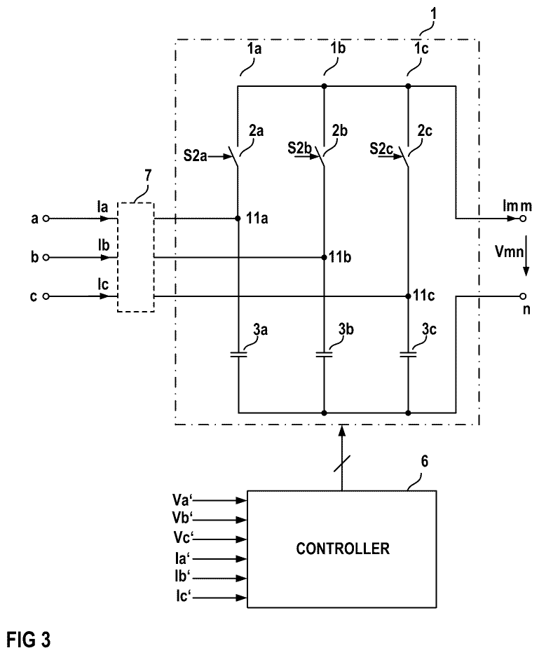

FIG. 3 illustrates one example of a switching circuit 1 that includes a three-phase half-bridge. The output at which the alternating voltage Vmn is available includes a first output node m and a second output node n. The switching circuit 1 is configured to selectively connect each of the input nodes a, b, c with only one of the first and second output nodes m, n. In the example illustrated in FIG. 3, the switching circuit 1 is configured to selectively connect each of the input nodes a, b, c with the first output node m. This is in contrast to a three-phase full-bridge switching circuit, which is configured to selectively connect each of three input nodes with each of two output nodes.

Referring to FIG. 3, the three-phase half-bridge includes three half-bridges 1a, 1b, 1c that each include a switched node (tap) 11a, 11b, 11c, an electronic switch 2a, 2b, 2c connected between the respective switched node 11a, 11b, 11c and the first output node m, and a capacitor 3a, 3b, 3c connected between the respective switched node 11a, 11b, 11c and the second output node n. The capacitors 3a, 3b, 3c may also be referred to as DC blocking capacitors. According to one example, the three capacitors 3a, 3b, 3c at least approximately have the same capacitance. Each of the electronic switches 2a, 2b, 2c switches on or off dependent on a control signal S2a, S2b, S2c that is generated by the control circuit 6.

Referring to FIG. 3, each of the three input nodes a, b, c is coupled to a respective one of the switched nodes 11a, 11b, 11c. This may include that each of the three input nodes a, b, c is directly connected to the respective one of the switched nodes 11a, 11b, 11c, or that each of the three input nodes a, b, c is connected to the respective switched node 11a, 11b, 11c via the optional input filter 7. It should be noted in this regard that the input filter 7 is configured to filter out high-frequency components of the input voltages Va, Vb, Vc and the input currents Ia, Ib, Ic, but does not affect the general waveforms of these voltages Va, Vb, Vc and currents Ia, Ib, Ic. The “general waveforms” are sinusoidal waveforms, for example.

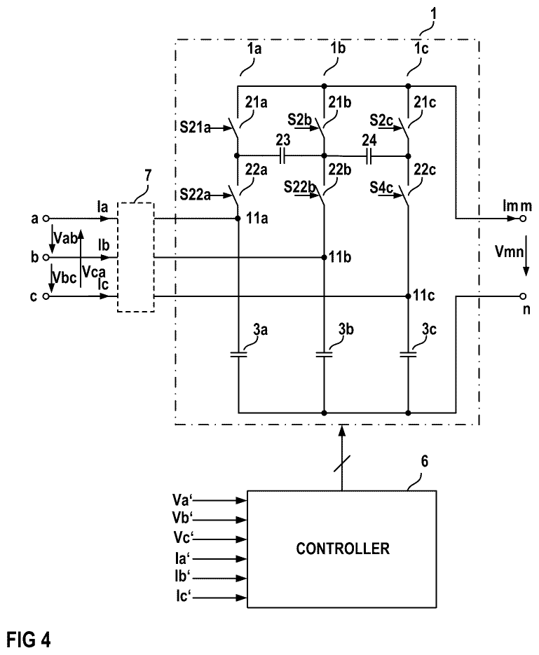

FIG. 4 shows a modification of the switching circuit 1 according to FIG. 3. The switching circuit 1 according to FIG. 4 is different from the switching circuit 1 according to FIG. 3 in that each half-bridge 1a, 1b, 1c includes two electronic switches 21a, 22a, 21b, 22b, 21c, 22c connected in series between the respective switched node 11a, 11b, 11c and the first output node m. A first capacitor 23 is connected between a circuit node at which the first and second switches 21a, 22a of a first one 1a of the half-bridges 1a, 1b, 1c are connected and a circuit node at which the first and second switches 21b, 22b of a second one of the half-bridges 1a, 1b, 1c are connected. Furthermore, a second capacitor 24 is connected between the circuit node at which the first and second switches 21b, 22b of the second half-bridge 1b are connected and the circuit node at which the first and second switches 21c, 22c of a third one of the half-bridges 1a, 1b, 1c are connected.

Each of the first and second electronic switches 21-22c switches on or off dependent on a respective control signal S21a, S21b, S21c, S22a, S22b, S22c that is generated by the control circuit 6. According to one example, the first and second switches connected in series are switched on and off synchronously. That is switches 21a, 22a connected between switched node 11a and the first output node m switch synchronously, switches 21b, 22b connected between switched node 11b and the first output node m switch synchronously, and switches 21c, 22c connected between switched node 11c and the first output node m switch synchronously.

The switches 21a-22c used in the switching circuit 1 according to FIG. 4 may have a lower voltage blocking capability than the switches 2a-2c used in the switching circuit according to FIG. 3. In the switching circuit according to FIG. 3, the voltage that may occur across each of the switches 2a-2c is given by the output voltage Vmn minus the respective input voltage Va, Vb, Vc. In the switching circuit 1 according to FIG. 4 the voltage that may occur across each of the switches 2a, 2b, 2c is lower because the first and second capacitors 23, 24 are charged during operation and thereby help to reduce the voltages across the switches 21a-21c, 22a-22c as compared to the voltages across the switches 2a-2c in the switching circuit according to FIG. 3. During operation of the switching circuit 1 according to FIG. 4, the voltage across the first capacitor 23 is essentially given by 50% of a voltage difference between the first and second input voltages Va, Vb, (Va-Vb)/2, and the voltage across the second capacitor 24 is essentially given by 50% of a voltage difference between the second and third input voltages Vb, Vc, (Vb-Vc)/2.

According to one example, the electronic switches in the switching circuit 1 are bidirectionally blocking electronic switches. That is, each of the electronic switches 2a-2c in the switching circuit 1 according to FIG. 3 and each of the electronic switches 21a-21c, 22a-22c in the switching circuit 1 according to FIG. 4 is a bidirectionally blocking electronic switch.

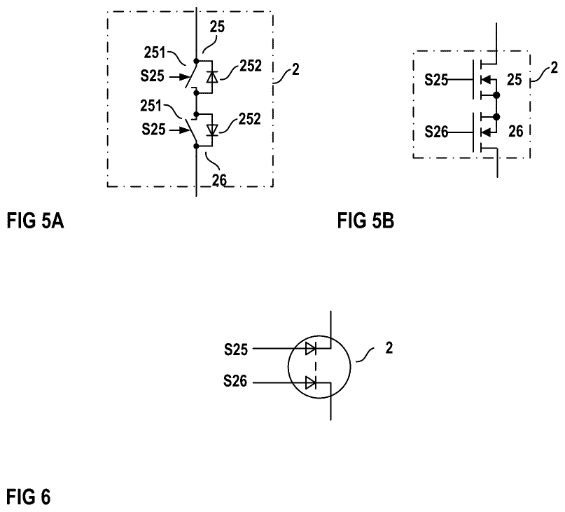

A “bidirectionally blocking electronic switch” is an electronic switch that, in the off-state, is configured to block independent of a polarity of a voltage applied across the electronic switch. A bidirectionally blocking electronic switch may be implemented in various ways. Examples are explained with reference to FIGS. 5A-5B and 6 in the following. In these figures, reference number 2 denotes an arbitrary one of the electronic switches 2a-2c, 21a-21c, 22a-22c in the switching circuit 1.

According to FIG. 5A, the bidirectionally blocking switch 2 may include two unidirectionally blocking electronic switches 25, 26 connected in series. These unidirectionally blocking electronic switches 25, 26 may be referred to as partial switches. A “unidirectionally blocking electronic switch” is an electronic switch that, in the off-state, is configured to block when a voltage applied across the switch has a first polarity and to conduct when the voltage has a second polarity opposite the first polarity. A unidirectionally blocking electronic switch can be considered to include a switching element 251, 261 and a freewheeling element 252, 262, such as a diode, connected in parallel with the switching element 251, 261. In the off-state, the switching element 251, 261 blocks independent of the polarity of the voltage across the electronic switch 25, 26, while the freewheeling element 252, 262 blocks when the voltage has the first polarity and conducts when the voltage has the second polarity.

The unidirectionally blocking electronic switches 25, 26 may be implemented in various ways. Basically, any type of electronic switching element and any type of rectifier element connected in parallel with the switching element may be used to implement the bidirectionally blocking electronic switch.

A MOSFET is a unidirectionally blocking electronic switch. Thus, as illustrated in FIG. 5B, the bidirectionally blocking electronic switch 2 may include two MOSFETs (Metal Oxide Semiconductor Field-Effect Transistors) that are connected in series such that internal body diodes of the MOSFETs are connected in anti-series. The body diode of a MOSFET acts as a freewheeling element and makes the MOSFET a unidirectionally blocking electronic switch.

According to another example illustrated in FIG. 6, the bidirectionally blocking electronic switch 2 is a bidirectionally blocking gallium nitride (GaN) switch. Such bidirectionally blocking GaN switch includes two GaN HEMTs (High Electron-Mobility Transistors) as partial switches that are connected in series in such a way that internal freewheeling elements are connected in anti-series. According to one example, the two GaN HEMTs are two single GaN HEMTs connected in series. According to another example, the two GaN HEMTs are monolithically integrated and each have a control node but share the same active area. Thus, a monolithic bidirectionally blocking GaN HEMT has the benefit of using the same active area (instead of two different active areas in the case of two single GaN HEMT is connected in series), which results in a reduced on-resistance, which is the electrical resistance in the on-state.

In each case, the bidirectionally blocking electronic switch 2 is configured to receive two drive signals S25, S26. That is, the bidirectionally blocking electronic switch is configured to receive a respective drive signal S25, S26 for each of the two partial switches. The bidirectionally blocking switch is in the off-state when each of the partial switches is in the off-state and is in the on-state when each of the partial switches is in the on-state. In the off-state, the bidirectionally blocking switch blocks independent of the polarity of the voltage applied across the switch. In the on-state, the bidirectionally blocking switch conducts independent of the polarity of the voltage applied across the switch. Furthermore, the bidirectionally blocking electronic switch 2 can be operated in a unidirectionally blocking/conducting state, which is an operating state in which one of the partial switches is switched on and the other one of the partial switches is switched off.

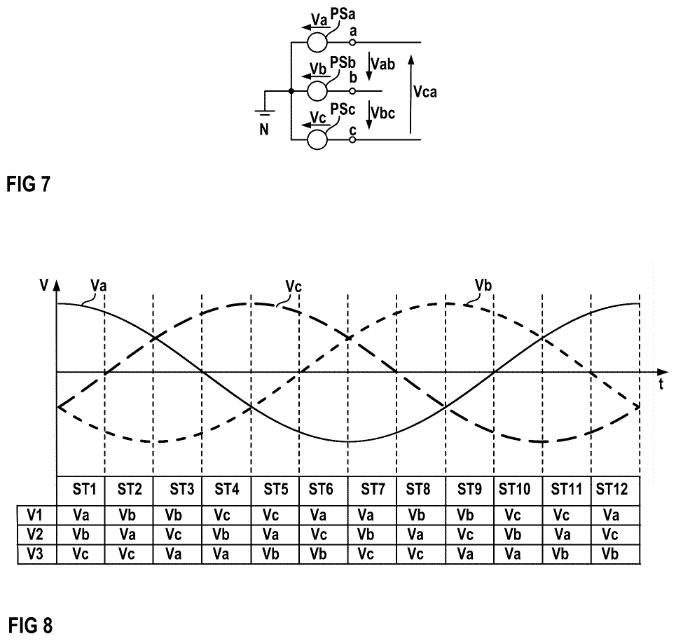

FIG. 7 schematically illustrates one example of a power supply configured to provide the alternating input voltages Va, Vb, Vc received at the input nodes a, b, c of the power converter. In this example, the power supply includes three power sources PSa, PSb, PSc each connected between a respective one of the three input nodes a, b, c and the common circuit node N. Each of these power sources PSa, PSb, PSc provides a respective one of the input voltages Va, Vb, Vc. The power supply is a three-phase power grid, for example.

Referring to the above, the input voltages Va, Vb, Vc may be sinusoidal input voltages. FIG. 8 shows signal diagrams of three sinusoidal input voltages Va, Vb, Vc, which may be provided by a three-phase power grid. FIG. 8 shows the signal waveforms over one period of each of these input voltages Va, Vb, Vc. Referring to FIG. 8, there is a phase shift between each pair of these input voltages Va, Vb, Vc, wherein the phase shift is 120° (2π/3), for example. A frequency of the input voltages Va, Vb, Vc, which is the reciprocal of the duration of one period, is 50 Hz or 60 Hz, for example. An RMS (root mean square) value of the input voltages Va, Vb, Vc is 230 VRMS or 110 VRMS, for example (wherein the three input voltages Va, Vb, Vc have the same RMS value). The amplitude of each of the input voltages Va, Vb, Vc is \sqrt{2} times the RMS value. As can be seen from FIG. 8, each of the three sinusoidal input voltages Va, Vb, Vc periodically changes between a negative minimum voltage level and a positive maximum voltage level. The magnitude (absolute value) of the minimum voltage level equals the magnitude of the maximum voltage level and equals the amplitude.

Over one period of an input voltage system that includes three input voltages Va, Vb, Vc at each time (except for time instances at which two of the three voltages Va, Vb, Vc cross) one of the input voltages Va, Vb, Vc is the highest input voltage, one of the input voltages Va, Vb, Vc is the second highest input voltage, and one of the input voltages Va, Vb, Vc is the lowest input voltage. It should be noted that “highest”, “second highest” and “lowest” relates to the magnitude of the respective voltage, so that the highest input voltage is that one of the input voltages Va, Vb, Vc that has the highest magnitude, the second highest input voltage is that one of the input voltages Va, Vb, Vc that has the second highest magnitude, and the lowest input voltage is that one of the input voltages Va, Vb, Vc that has the lowest magnitude.

As the input voltages Va, Vb, Vc are alternating input voltages and are out of phase with each other the input voltage being the highest input voltage, the input voltage being the second highest input voltage, and the input voltage being the lowest input voltage changes several times over one period of the input voltages Va, Vb, Vc. As can be seen from FIG. 8, the input voltage being the highest input voltage is the same for a certain time period, the input voltage being the second highest input voltage is the same for a certain time period, and the input voltage being the lowest input voltage is the same for a certain time period. More specifically, in an input voltage system that includes three sinusoidal input voltages with a mutual phase shift of 120° there are 12 different time segments in each period of the input voltage system such that during each of these 12 different times segments the same input voltage is the highest input voltage, the same input voltage is the second highest input voltage, and the same input voltage is the lowest input voltage. These 12 different times segments are also referred to as states of the input voltage system and are labeled with ST1-ST12 in FIG. 8. The duration of each of the 12 states ST1-ST12 is 1/12 (30°, π/6) of one period of the input voltage system.

FIG. 8 includes a table that illustrates which of the input voltages Va, Vb, Vc in each of the different states ST1-ST12 is the highest input voltage, the second highest input voltage, and the lowest input voltage. In FIG. 8, V1 denotes the highest input voltage, V2 denotes the second highest input voltage, and V3 denotes the lowest input voltage.

In a first state ST1 of the input voltage system, for example, the highest input voltage V1 is the first input voltage Va, V1=Va; the second highest input voltage V2 is the second input voltage Vb, V2=Vb; and the lowest input voltage V3 is the third input voltage Vc, V3=Vc. In a sixth state ST6 of the input voltage system, for example, the highest input voltage V1 is the first input voltage Vc, V1=Va; the second highest input voltage V2 is the third input voltage Va, V2=Vc; and the lowest input voltage V3 is the second input voltage Vb, V3=Vb.

In each of the different states ST1-ST12 the highest input voltage V1 has a first polarity and the second highest input voltage V2 and the lowest input voltage V3 have a second polarity opposite the first polarity. In the first state ST1, for example, the highest input voltage V1 (which is the first input voltage Va) is positive, while the second highest input voltage V2 (which is the second input voltage Vb) and the lowest input voltage V3 (which is the third input voltage Vc) are negative. In the sixth state ST6, for example, the highest input voltage (which is the first input voltage Vout for) is negative, while the second highest input voltage V2 (which is the third input voltage Vc) and the lowest input voltage V3 (which is the second input voltage Vb) are positive.

As can be seen from FIG. 8, the 12 states ST1-ST12 include six pairs of states such that in the two states of each pair the same input voltage is the highest input voltage, the same input voltage is the second highest input voltage V2, and the same input voltage is the lowest input voltage V3. These six pairs of states are: (ST1, ST7), (ST2, ST8), (ST3, ST9), (ST4, ST10), (ST5, ST11), (ST6, ST12). However, the highest input voltages in each pair have opposite polarities, the second highest input voltages in each pair have opposite polarities, and the lowest input voltages in each pair have opposite polarities. Thus, the 12 states ST1-S12 of the input voltage system that occur during one period of the input voltage system are unique (mutually different). That is, only one of the 12 states include a certain highest input voltage with a certain polarity, a certain second highest input voltage with a certain polarity, and a certain lowest input voltage with a certain polarity.

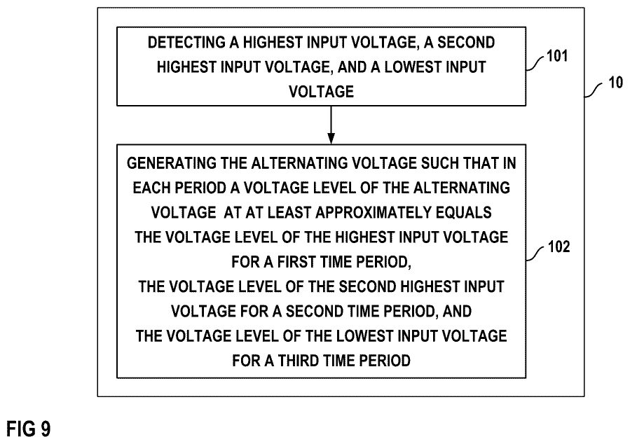

Referring to FIG. 2, the method 10 for generating the alternating voltage Vmn includes controlling the waveform of the alternating voltage Vmn dependent on the signal levels of the output voltage and includes controlling the power factor of the power Pin received at the input a, b, c. One way of generating the alternating voltage Vmn in this way is illustrated in. Referring to FIG. 9, the method 10 includes (101) detecting the highest input voltage V1, the second highest input voltage V2, and the lowest input voltage V3 of the three input voltages Va, Vb, Vc; and (102) generating the alternating voltage Vmn such that in each period of the alternating voltage Vmn the voltage level of the alternating voltage Vmn at least approximately equals the voltage level of the highest input voltage V1 for a first time period, the voltage level of the second highest input voltage V2 for a second time period, and the voltage level of the lowest input voltage V3 for a third time period.

The voltage level of the alternating voltage Vmn being “at least approximately” equal to the voltage level of the highest, the second highest, or the lowest voltage level includes that in an ideal case, in which there are no losses in the switching circuit 1 and the filter 7, the voltage level of the alternating voltage Vmn equals the voltage level of the respective one of the highest, the second highest, or the lowest input voltage Va, Vb, Vc. In a real system, however, such losses may reduce the magnitude of the alternating voltage Vmn as compared to the magnitude of the respective one of the highest, the second highest, and the lowest input voltage V1, V2, V3. Thus, the magnitude of the alternating voltage Vmn equals the magnitude of the respective one of the highest, the second highest, or the lowest input voltage V1, V2, V3 minus inevitable losses in the switching circuit 1 and the filter 7.

In the method according to FIG. 9, generating the alternating voltage Vmn based on the input voltages Va, Vb, Vc includes, in each period of the alternating voltage Vmn, connecting the first output node m to that one of the input nodes a, b, c receiving the highest input voltage V1 for the first time duration, to that one of the input nodes a, b, c receiving the second highest input voltage V2 for the second time duration, and to that one of the input nodes a, b, c receiving the lowest input voltage V3 for the third time duration. At each time instance, the polarity of the alternating voltage Vmn equals the polarity of the input voltage that forms the alternating voltage Vmn at the respective time instance.

Referring to FIGS. 3 and 4, in the switching circuit 1 with the three-phase half-bridge, the second output node n is coupled to each of the switched nodes 11a, 11b, 11c via a respective one of the three capacitors 3a, 3b, 3c. The electrical potential at the second output node n at least approximately equals the electrical potential at the reference node N. Thus when the switching circuit 1 couples the first output node m to a respective one of the input nodes a, b, c the voltage level of the alternating voltage Vmn at least approximately equals the voltage level of the input voltage Va, Vb, Vc at the respective input node a, b, c.

According to one example, the second output node n is not electrically connected to the reference node N of the input voltage system. Nevertheless, the electrical potential at the second output node n can be at least approximately equal to the electrical potential at a reference node N if, for example, the input voltage system is a three-phase sinusoidal voltage system including three sinusoidal voltages with a relative phase shift of 120°.

According to another example, the second output node n is electrically connected to the reference node N. This is illustrated in dashed lines in FIG. 1. In this case, the second output node n and the reference node N have the same electrical potential even if the input voltage system is not a three-phase sinusoidal input voltage system.

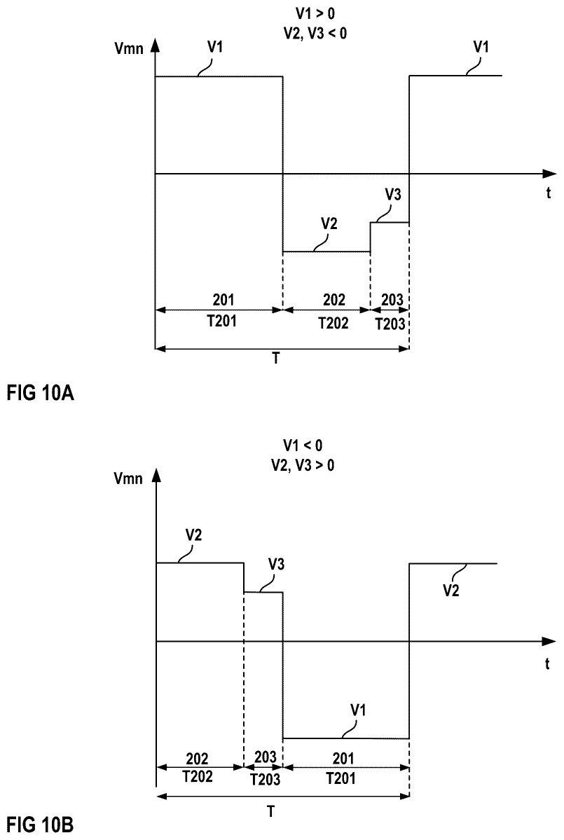

FIGS. 10A-10B schematically illustrate examples of the alternating voltage Vmn generated in accordance with the method according to FIG. 9. Each of FIGS. 10A-10B illustrates one period of the alternating voltage Vmn. In FIGS. 10A-10B, T denotes the duration of one period. The frequency f of the alternating voltage Vmn is the reciprocal of the duration T of one period, f=1/T. According to one example, the frequency f of the alternating voltage Vmn is fixed.

According to one example, the frequency f of the alternating voltage Vmn is much higher than the frequency of the alternating input voltages Va, Vb, Vc and, for example, is at least 1000 (10³) times the frequency of the input voltages Va, Vb, Vc so that each of the input voltages Va, Vb, Vc can be considered to be essentially equal over one duration of the alternating voltage Vmn. According to one example, the frequency f of the alternating intermediate voltage Vmn is selected from between 100 kHz and 2 MHz, in particular from between 300 kHz and 1 MHz.

FIG. 10A illustrates one period of the alternating voltage Vmn in a scenario in which the highest input voltage V1 is positive and the second highest input voltage V2 and the lowest input voltage V3 are negative. FIG. 10B illustrates one period of the alternating voltage Vmn in a scenario in which the highest input voltage V1 is negative and the second highest input voltage V2 and the lowest input voltage V3 are positive. In each example, one period of the alternating voltage Vmn includes three time periods (time segments), (a) a first time period 201 in which the voltage level of the alternating voltage Vmn (at least approximately) equals the voltage level of the highest input voltage V1; (b) a second time period 202 in which the voltage level of the alternating voltage Vmn (at least approximately) equals the voltage level of the second highest input voltage V2; and a third time period 203 in which the voltage level of the alternating voltage Vmn (at least approximately) equals the voltage level of the lowest input voltage V3. In FIGS. 10A-10B, T201 denotes a time duration of the first time period 201, T202 denotes a time duration of the second time period 202, and T203 denotes a time duration of the third time period 203.

In the examples illustrated in FIGS. 10A-10B each of the first, second, and third time periods 201, 202, 203 is a contiguous time period. This, however, is only an example it is also possible to subdivide each of these time periods into two or more sub-periods and to distribute the individual sub-periods over the period T in an arbitrary way. This, however, increases the number of switching operations of the switching circuit 1 and may result in increased switching losses.

In the example illustrated in FIG. 10A, the first, second, and third time periods 201, 202, 203 occur in the following order: 201-202-203, and in the example illustrated in FIG. 10B, the first, second, and third time period 201, 202, 203 occur in the following order: 202-203-201. This, however, is only an example. The order in which these time period 201, 202, 203 occur, is arbitrary. In the example illustrated in FIG. 10A, for example, the individual time periods may also occur in the following order: 201-203-202, and in the example illustrated in FIG. 10B, for example, the individual time period may also occur in one of the following orders: 203-202-201.

Referring to the above, the time duration T of one period of the alternating voltage Vmn is so short as compared to the duration of one period of the input voltages Va, Vb, Vc that the input voltages Va, Vb, Vc can be considered to be essentially constant over this time duration T.

Referring to the above, in each of the different states ST1-ST12 the highest input voltage V1 has a polarity different from the polarities of the second highest input voltage V2 and the lowest input voltage V3. Thus, by selecting the highest input voltage V1 to form the voltage Vmn for the first time duration T201, selecting the second highest input voltage V2 to form the voltage Vmn for the second time duration, and selecting the lowest input voltage V3 to form the voltage Vmn for the third time duration T203 the alternating character of the voltage Vmn is achieved. When the highest input voltage V1 is positive and the second highest and lowest input voltages V2, V3 are negative, the highest input voltage V1 forms a positive half-period and the second highest and lowest input voltages V2, V3 form a negative half-period of the input voltage. When the highest input voltage V1 is negative and the second highest and lowest input voltages V2, V3 are positive, the highest input voltage V1 form a negative half-period and the second highest and lowest input voltages V2, V3 form a positive half-period of the alternating voltage Vmn.

According to one example, the individual time periods are generated such that the second and third time periods 202, 203 are timely successive time period. Furthermore, the individual time periods of the alternating voltage Vmn may be generated such that that the polarity of the alternating voltage Vmn changes at the end of one time period T and the beginning of the following time period T. If, for example, the input voltage system changes from one state in which the highest input voltage V1 is positive to another state in which the highest input voltage V1 is negative, the order in which the individual time periods occur may change from the order illustrated in FIG. 10A to the order illustrated in FIG. 10B or from the order illustrated in FIG. 10B to the order illustrated in FIG. 10A in order to achieve a change of polarity of the alternating voltage Vmn between two successive periods.

According to one example, the duration T201 of the first time period 201 at least approximately equals 50% of the time duration T of one period of the alternating voltage Vmn,

$$T 201 \approx 0.5 \cdot T . \qquad ( 2 a )$$

In this example, an overall duration of the first and second time periods 202, 203 at least approximately equals 50% of the time duration T of one period of the alternating voltage Vmn,

$$T 202 + T 203 \approx 0.5 \cdot T . \qquad ( 2 b )$$

It can be shown that by suitably adjusting the second and third time durations T202, T203 under consideration of equation (2b) a PFC functionality of the power converter can be achieved. “Achieving a PFC functionality”, according to one example, includes that the power factor of the power Pin received at the input is higher than 90%, higher than 95%, or even higher than 99%.

As explained above, the alternating voltage Vmn is generated by the switching circuit 1 based on the input voltages Va, Vb, Vc, wherein the switching circuit 1 is controlled by the controller 6. The switching circuit 1, controlled by the controller 6, may have three different operating states. In each of these operating states there is an electrically conductive path between one of the switched nodes 11a, 11b, 11c and the first output node m, so that the input node a, b, c connected to the respective switched node 11a, 11b, 11c is connected to the first output node m, while conductive paths between the other two of the switched nodes 11a, 11b, 11c and the first output node m are interrupted. In the switching circuit according to FIG. 3, for example, a conductive path between one of the switched nodes 11a, 11b, 11c and the first output node m can be achieved by switching on the respective electronic switch 2a, 2b, 2c. In the switching circuit according to FIG. 4, for example, a conductive path between one of the switched nodes 11a, 11b, 11c and the first output node m can be achieved by switching on the first and second electronic switches 21a-21c, 22a, 22c connected in series between the respective switched node 11a, 11b, 11c, and the first output node m.

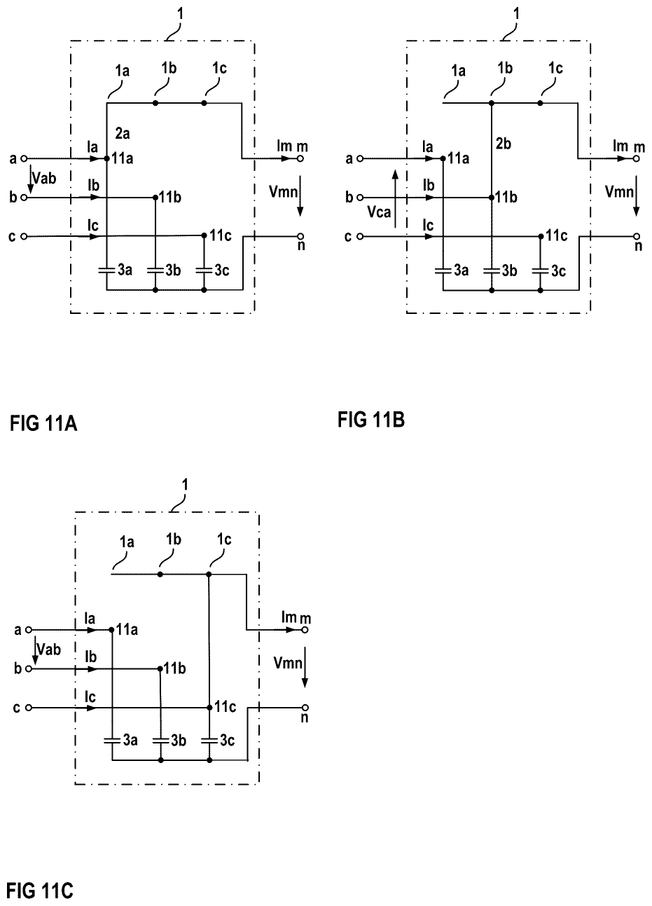

The three different operating states of the switching circuit 1 are schematically illustrated in FIGS. 11A-11C. In each of these figures, a conductive path between one of the first, second, and third switched nodes 11a, 11b, 11c and the output node m is represented by a solid line, and an interrupted conductive path is represented by a missing line between the respective switched node 11a, 11b, 11c and the first output node m.

FIG. 11A illustrates a first operating state, which is an operating state in which there is a conductive path between the first switched node 11a and the first output node m and in which conductive paths between the second switched node 11b and the first output node m and between the third switched node 11c and the first output node m are interrupted.

FIG. 11B illustrates a second operating state, which is an operating state in which there is a conductive path between the second switched node 11b and the first output node m and in which conductive paths between the first switched node 11a and the first output node m and between the third switched node 11c and the first output node m are interrupted.

FIG. 11C illustrates a third operating state, which is an operating state in which there is a conductive path between the third switched node 11c and the first output node m and in which conductive paths between the first switched node 11a and the first output node m and between the second switched node 11b and the first output node m are interrupted.

One example of a controller 6 that is configured to detect the state of the input voltage system and control operation of the switching circuit 1 in accordance with the detected state is illustrated in FIG. 9 and explained in the following.

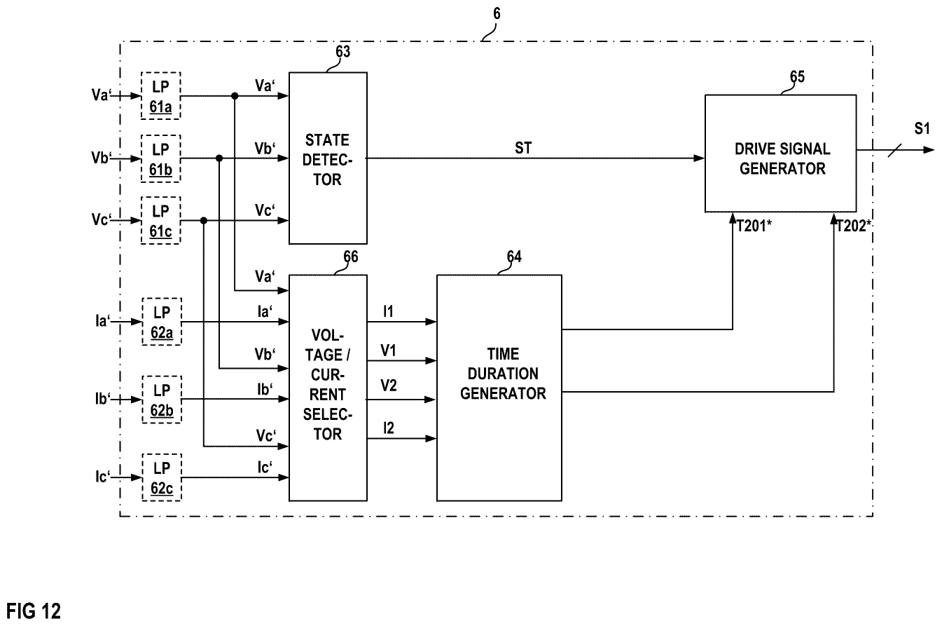

FIG. 12 shows a block diagram of one example of the controller 6. It should be noted that the block diagram according to FIG. 12 illustrates the functionality rather than the implementation of the controller 6. According to one example, the controller 6 may be implemented using dedicated circuitry. According to another example, the controller 6 may include a microcontroller that executes a software that is configured to operate the microcontroller in such a way that the functionality illustrated in FIG. 12 is implemented.

Referring to FIG. 9, the controller 6 receives the measured input voltages Va′, Vb′, Vc′ and the measured input currents Ia′, Ib′, Ic′. According to one example, the input voltages and the input currents are measured between the input filter 7 and the switching circuit 1. Referring to the above, the switching circuit 1 operates at a much higher frequency than the input voltages in order to generate the alternating voltage Vmn. The switched-mode operation of the switching circuit 1 may cause voltage ripples of the input voltages Va, Vb, Vc and current ripples of the input currents Ia Ib, Ic measured between the input filter 7 and the switching circuit 1. In order to prevent such current and voltage ripples from negatively affecting operation of the power converter, the measured input voltages Va′, Vb′, Vc′ may be filtered by respective filters 61a, 61b, 61c to obtain filtered measured input voltages and the measured input currents Ia′, Ib′, Ic′ may be filtered by respective filters 62a, 62b, 62c to obtain filtered measured input currents.

The filters 61a, 61b, 61c, 62a, 62b, 62c are low-pass filters, for example. According to one example, the low-pass filters are configured to average the measured input currents Ia′ Ib′, Ic′ and measured input voltages Va′, Vb′, Vc′ over time durations that are between about one time and 100 times, in particular, between 10 times and 50 times the period T of the alternating voltage Vmn.

According to another example, the input voltages Va, Vb, Vc and the input currents Ia, Ib, Ic are measured directly at the inputs a, b, c, that is, between the inputs a, b, c and the input filter 7. In this case, the filters 61a, 61b, 61c, 62a, 62b, 62c may be omitted.

Referring to FIG. 9, a state detector 63 receives the measured (and optionally filtered) input voltages Va′, Vb′, Vc′, which represent the input voltages Va, Vb, Vc, and detects the state of the input voltage system. That is, based on the measured input voltages Va′, Vb′, Vc′, the state detector 63 detects the one of the 12 possible states the input voltage system is currently in. The state detector 63 may detect the state of the input voltage system by detecting which one of the input voltages Va, Vb, Vc is currently the highest input voltage V1, which one of the input voltages Va, Vb, Vc is currently the second highest input voltage V2, in which one of the input voltages Va, Vb, Vc is currently the lowest input voltage V3.

A state signal ST output by the state detector 63 represents the state of the input voltage system detected by the state detector 63. A drive signal generator 65 receives the state signal ST and receives a first time duration reference T201* and a second time duration reference T202* from a time duration generator 64. The first time duration reference T1* represents the desired time duration T201 in which the voltage level of the alternating voltage Vmn equals the voltage level of the highest input voltage V1. The second time duration reference T202* represents the desired time duration T202 in which the voltage level of the alternating voltage Vmn equals the voltage level of the second highest input voltage V2. The drive signal generator 65 drives the electronic switches included in the switching circuit 1 in order to control the operation state of the switching circuit 1. In FIG. 12, S1 represents the plurality of control signals generated by the drive signal generator 65 for controlling operation of the electronic switches.

As can be seen from FIGS. 10A-10B and 11A-11C, in each period of the alternating voltage Vmn, the switching circuit 1 operates in its three different operating states in a predefined order. The order, in which the three different operating states occur, is dependent on the respective state ST1-ST12 of the input voltage system, so that in each period the voltage level of the alternating voltage Vmn is given by the voltage level of highest input voltage V1 for the first time duration T201, the second highest input voltage V2 for the second time duration T202, and the voltage level of the lowest input voltage V3 for the third time duration T203. The information on the instantaneous state of the input voltage system is included in the state signal ST received by the drive signal generator 65 from the state detector 63. The information on the first, second, and third time durations T21, T22, T203 is included in the first and second time duration references T201*, T202*. The first time duration reference T201* defines the first time duration T201, the second time duration reference T202* defines the second time duration T202, and the third time duration T203 is given by the predefined overall duration T of one period of the alternating voltage Vmn minus the first and second time durations T201, T202, T203=T-T201-T202. Thus, receiving the state signal ST and the first and second time duration references T201*, T202* enables the drive signal generator 65 to control the switching circuit 1 such that the switching circuit 1 operates in the three different operating states in the correct order and for the respective correct time duration such that the alternating voltage Vmn is generated in accordance with the method explained herein before.

Referring to FIG. 12, the time duration generator 64 receives a signal that represents the highest input voltage V1 and the associated input current I1. If, for example, the first input voltage Va is the highest input voltage, the associated input current is the input current 1a received at the first input a. Furthermore, the time duration generator 64 receives a signal that represents the second highest input voltage V2 and the associated input current 12, which is the current received at the same input node at which the second highest input voltage V2 is received.

The signal representing the highest input voltage V1, the associated input current I1, the second highest input voltage V2, and the associated input current 12 are provided by a voltage/current selector 66 based on the measured (and optionally filtered) input voltages Va′, Vb′, Vc′ and the measured (and optionally filtered) input currents Ia′, Ib′, Ic′.

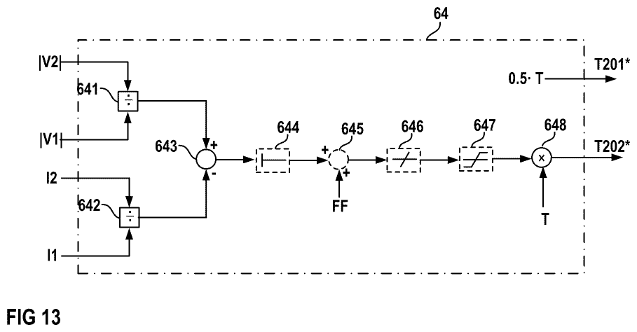

According to one example, the time duration generator 64 is configured to generate the first and second time duration references T201*, T202* based on the highest and second highest input voltage V1, V2 and the associated input currents 11, 12 in order to control the power factor. FIG. 13 illustrates one example of the time duration generator 64 in detail.

Referring to FIG. 13, the time duration generator 64 generates the first time duration reference T201* to be equal to 50% of the time duration T of one period. This is in accordance with equation (2a) provided herein above. Furthermore, the time duration generator 64 generates the second time duration reference T202* dependent on a first ratio between a magnitude |V2| of the voltage level of the second highest input voltage V2 and a magnitude |V1| of the voltage level of the highest input voltage V1, and dependent on a second ratio between a magnitude |12| of the input current 12 associated with the second highest input voltage V2 and a magnitude |11| of the input current associated with highest input voltage V1. The time duration generator 64 according to FIG. 13 is configured to generate the second time duration T202* such that the higher the ratio between the magnitudes |V2|, |V1| of the second highest and the highest input voltage V2, V1 the longer the second time duration reference T202*.

In the time duration generator according to FIG. 13, a first divider 641 calculates the first ratio based on the magnitudes |V2|, |V1| of the second highest and the highest input voltage V2, V1, and a second divider 642 calculates the second ratio based on the magnitudes |12|, |11| of the current 12 associated with the second highest input voltage V2 and the current I1 associated with the highest input voltage V1, and a subtractor 643 subtracts the second ratio from the first ratio. If, for example, the magnitudes |V2|, |V1| of the second highest and the highest input voltage V2, V1 are equal and the magnitudes |12|, |11| of the current 12 associated with the second highest input voltage V2 and the current I1 associated with the highest input voltage V1 are equal, the output of the subtractor 643 is this zero and the second time duration reference T202* is zero.

For generating the second time duration reference T202* based on the output of the subtractor 643, the time duration generator 64 further includes a multiplier 648 that multiplies the output of the subtractor 643 with a value that represents the time duration T of one period of the alternating voltage Vmn. Optionally, the output of the subtractor 643 is processed by at least one of the following: a proportional regulator 644 that receives the output of the subtractor 643; an adder 645 that adds a feedforward variable FF to the output of the subtractor 643; a slope limiter 646 that is configured to limit a slope of an increase or a decrease of the subtractor 643 output; or a limiter 643 that is configured to limit the subject or output (plus the optional feedforward variable FF) to a predefined upper and lower value. The feedforward variable is selected from a range of between 0 and 1, in particular of between 0 and 0.5, for example.

By generating the alternating voltage Vmn in the way explained hereinabove, current waveforms of the input currents Ia, Ib, Ic are controlled to be dependent on voltage waveforms of the input voltages Va, Vb, Vc in order to control the power factor. More specifically, the input currents Ia, Ib, Ic are controlled such that current waveforms of the average input currents Ia, Ib, Ic correspond to the voltage waveforms of the input voltage is Va, Vb, Vc. “To correspond” in this context includes that the current waveforms have the same frequency and type of waveform as the voltage waveforms. Amplitudes of the average input currents Ia, Ib, Ic and, consequently, an amplitude of an output current Im provided at the output nodes m, n may vary dependent on the power consumption of a load connected to the power converter.

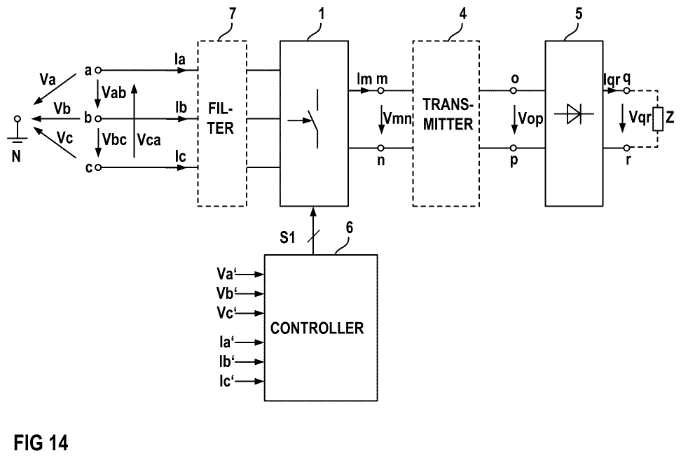

As explained above and as illustrated in dashed lines in FIG. 1, the alternating voltage Vmn may directly be received by a load Z connected to the output nodes m, n. Another example is illustrated in FIG. 14.

In the example illustrated in FIG. 14, the power converter further includes a rectifier 5 that is configured to receive the alternating voltage Vmn and rectify the alternating voltage Vmn to generate a rectified voltage Vqr at rectifier output nodes q, r. The rectified output Vqr voltage may be received by a load (illustrated in dashed lines in FIG. 14). According to another example (not illustrated), the power converter further includes a DC-DC converter stage that is configured to provide a regulated output voltage based on the rectified voltage Vqr provided by the rectifier 5.

A power converter of the type illustrated in FIG. 14 that includes the switching circuit 1 that is configured to generate the alternating voltage Vmn and control the power factor, and that includes the rectifier 5 may be referred to as PFC rectifier.

Optionally, as illustrated in dashed lines in FIG. 14, the power converter further includes a transmitter circuit 4 connected between the switching circuit 1 and the rectifier 5. The transmitter circuit 4 is configured to transmit electric power associated with the alternating voltage Vmn over a galvanic isolation barrier provided by the transmitter circuit 4. Transmitting power received from the input a, b, c (via the switching circuit 1) by the transmitter 4 is as associated with generating a further alternating voltage Vop at an output o, p of the transmitter circuit 4. In this example, the rectifier circuit 5 is configured to receive the further alternating voltage Vop and generate the rectified Vqr based on the further alternating voltage Vop.

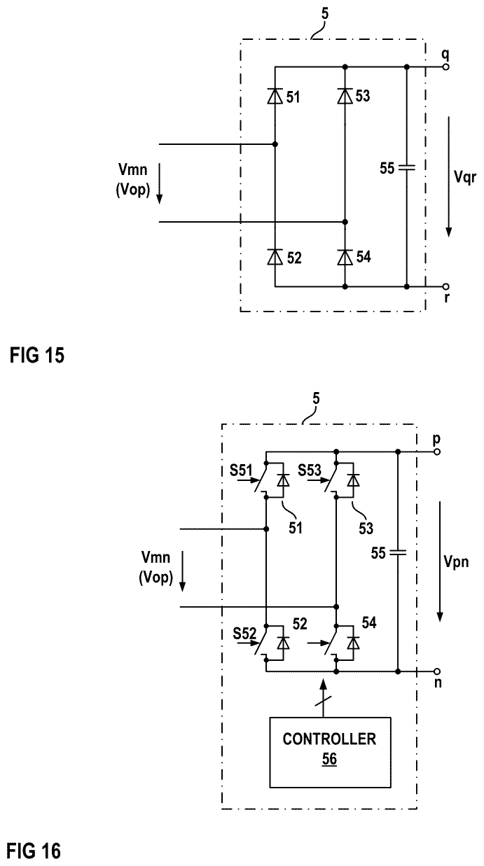

FIG. 15 illustrates one example of the rectifier circuit 5 that is configured to either receive the alternating voltage Vmn from the switching circuit 1 or the alternating voltage Vop from the transmitter circuit 4. The rectifier circuit 5 is configured to rectify the alternating voltage Vmn (Vop). The rectifier circuit 5 according to FIG. 11 is a passive rectifier that includes a rectifier bridge with four passive rectifier elements 51-54 which are connected between the input where the alternating voltage Vmn (Vop) is available and the rectifier output q, r. The rectifier elements are diodes, for example. The rectifier circuit 5 may further include a capacitor 55 connected between the output nodes q, r.

Implementing the rectifier circuit 5 with passive rectifier elements is only an example. In order to reduce conduction losses, the passive rectifier elements may be replaced by active rectifier elements. FIG. 16 illustrates one example of a rectifier circuit 5 implemented with active rectifier elements.

Referring to FIG. 16, the rectifier circuit 5 includes active rectifier elements 51-54 instead of passive rectifier elements. The active rectifier elements 51-53 are controlled by a rectifier controller 56. Each of the active rectifier elements 51-54 may include an electronic switch and a passive rectifier element, such as a diode, connected in parallel with the respective electronic switch. According to one example, the controller 56 is configured to detect whether the passive rectifier element of the respective active rectifier element is in a forward biased (conducting) or a reverse biased (blocking) state and is configured to switch on those electronic switches that are connected in parallel to a forward biased passive rectifier element. It should be noted that a rectifier circuit 5 with active rectifier elements 51-54 of the type illustrated in FIG. 16 is commonly known, so that no further explanation is required in this regard.

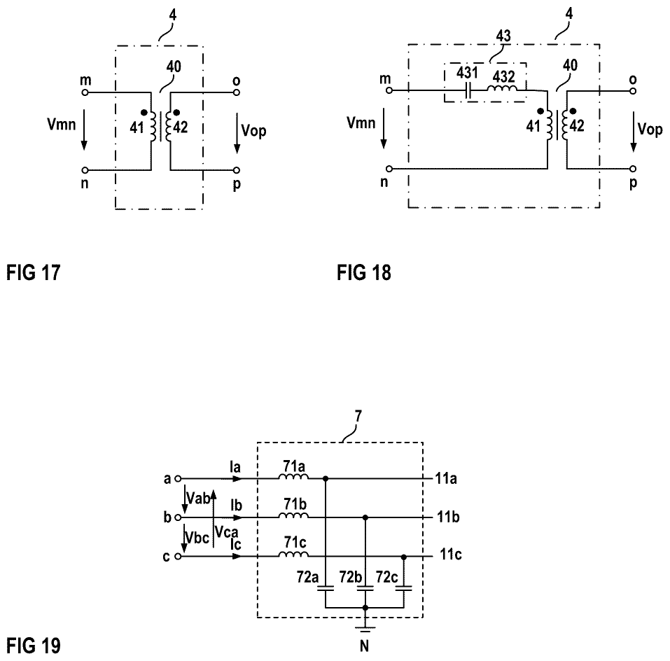

FIG. 17 illustrates one example of the optional transmitter circuit 4. In this example, the transmitter circuit 4 includes a transformer 40 with a primary winding 41 and a secondary winding 42. The primary winding 41 is connected between the input nodes m, n of the transmitter circuit 4, so that the primary winding 41 receives the alternating intermediate voltage Vmn. The secondary winding 42 is inductively coupled with the primary winding 41. According to one example, the primary winding 41 and the secondary winding 42 have the same winding sense, so that, at the secondary winding 42, a voltage Vop is available that is essentially proportional to the voltage across the primary winding 41. A proportionality factor between the voltage Vop across the secondary winding 42 and the voltage across the primary winding 41 is given by a ratio Ns/Np between the number of turns Ns of the secondary winding 42 and the number of turns Np of the primary winding 41.

The turns ratio Ns/Np may be such that the voltage Vop across the secondary winding 42 is lower than the voltage across the primary winding 41. In this example, the power converter operates as a step down converter. According to one example, the number of turns of the secondary winding 42 and the primary winding 41 are adapted to one another such that the voltage Vop across the secondary winding is between ½ and 1/20 of the voltage across the primary winding 41. That is, the number of turns Np of the primary winding 41 is between 2 times and 20 times the number of turns Ns of the secondary winding 42.

According to another example, the turns ratio Ns/Np is such that the voltage Vop across the secondary winding 42 is higher than the voltage across the primary winding 41. In this example, the power converter operates as a step up converter. According to one example, the number of turns of the secondary winding 42 and the primary winding 41 are adapted to one another such that the voltage Vop across the secondary winding is between 2 times and 20 times of the voltage across the primary winding 41. That is, the number of turns Np of the primary winding 41 is between ½ and 1/20 of the number of turns Ns of the secondary winding 42.

According to yet another example, the turns ratio Ns/Np is 1/1, so that the primary winding 41 and the secondary winding 42 have the same number of turns. In this example, the transmitter circuit 4 merely serves to galvanically isolate the nodes q, r where the alternating voltage Vop is available from the input a, b, c.

FIG. 18 illustrates a modification of the transmitter circuit according to FIG. 17. In the power converter according to FIG. 18, the transmitter circuit 4 further includes a resonant circuit 43 connected in series with the primary winding 41 of the transformer 40. In this example, the alternating intermediate voltage Vmn is received by a series circuit including the resonant circuit 43 and the primary winding 41 of the transformer 40. Like in the example according to FIG. 17, the voltage Vop across the secondary winding 42 is proportional to the voltage across the primary winding 41. in the transmitter circuit according to FIG. 18, however, the voltage across the primary winding 41, is different from the alternating voltage Vmn provided by the switching circuit 1.

Referring to FIG. 18, the resonant circuit 43 includes a capacitor 431 connected in series with an inductor 432. The inductor 432 can be a discrete inductor connected in series with the primary winding 41. According to another example, the inductor 432 is formed by the primary winding 401 and is formed by a parasitic inductance of the transformer 40.

The resonant circuit 43 has a resonant frequency. According to one example, the alternating voltage Vmn is generated such that its frequency is higher than the resonant frequency of the resonant circuit 43. According to one example, the alternating voltage Vmn is generated such that it is frequency is higher than the resonant frequency of the resonant circuit 4 and lower than twice the resonant frequency of the resonant circuit 43, that is,

$$fres < f < 2 \cdot fres , \qquad ( 7 )$$

where f denotes the frequency of the alternating intermediate voltage Vmn, and fres denotes the resonant frequency of the resonant circuit 4.

For the sake of completeness, FIG. 19 illustrates one example of the input filter 7. In this example, the filter 7 includes three inductors 71a, 71b, 71c, wherein each of these inductors 71a, 71b, 71c is connected between a respective one of the input nodes a, b, c and the respective switched node 11a, 11b, 11c. Furthermore, a capacitor 72a, 72b, 72c is connected between each switched node 11a, 11b, 11c and the reference node N. Implementing the filter 7 as illustrated in FIG. 19, however, is only an example. Any other type of input filter may be used as the filter 7 in the power converter as well.

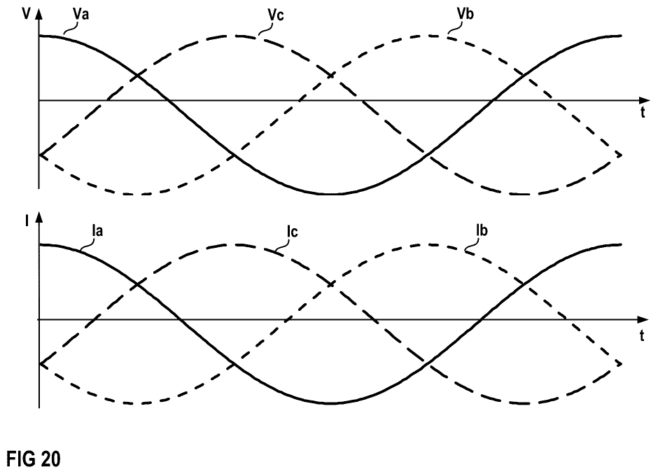

Operating the power converter in the unregulated fashion explained hereinabove results in input currents Ia, Ib, Ic that are essentially proportional to the input voltages Va, Vb, Vc so that the power factor is higher than 90% and may even be higher than 99%. FIG. 20 shows signal waveforms of the input voltages Va, Vb, Vc and signal waveforms of the corresponding input currents Ia, Ib, Ic over one period. As can be seen from FIG. 20, the input currents Ia, Ib, Ic are almost exactly proportional to the input voltages Va, Vb, Vc. and only include slight current ripples that result from the switched-mode operation of the switching circuit 1.

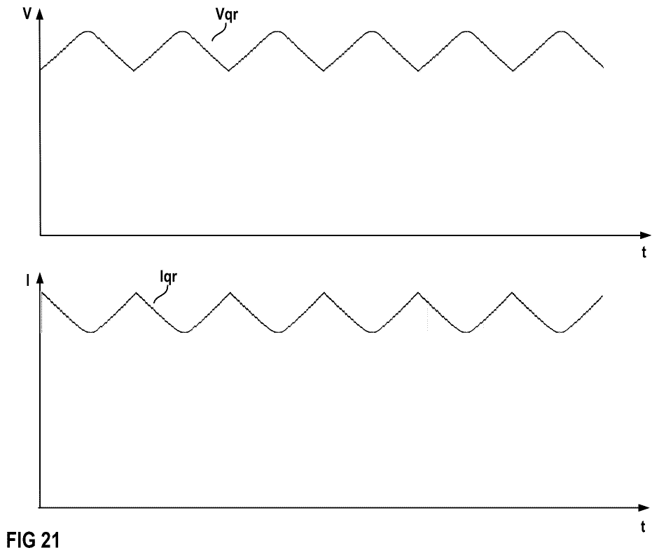

FIG. 21 illustrates one example of the output voltage Vqr and the corresponding output current Iqr in a power converter of the type illustrated in FIG. 14 that, in addition to the switching circuit 1, includes a rectifier circuit 5 and an optional transmitter 4. FIG. 21 illustrates the output voltage Vqr and the corresponding output current Iqr over one period of an input voltage system of the type illustrated in FIG. 8.

In an input voltage system of the type illustrated in FIG. 8, which includes three sinusoidal voltages Va, Vb, Vc, magnitudes of the input voltages Va, Vb, Vc define a six-pulse waveform. This six-pulse waveform, at each time, is defined by the magnitude of the instantaneously highest one of the input voltages Va, Vb, Vc. As can be seen from FIG. 21, the output voltage Vqr is essentially constant but may include voltage ripples that are in correspondence with the six-pulse waveform of the input voltage system. The output current Iqr includes corresponding current ripples. The magnitude of the voltage ripples of the output voltage Vqr is, inter alia, dependent on a capacitance of the output capacitor 55 of the rectifier circuit. Basically, the higher the capacitance, the lower the magnitude of the voltage ripples.

As explained above, the electronic switches 2a, 2b, 2c (or 21a-21c, 22a-22c) included in the switching circuit 1 are bidirectionally blocking switches. Furthermore, as explained above, each of the bidirectionally blocking switches may include two partial switches, wherein a bidirectionally blocking switch is in the on-state when the two partial switches are in the on-state and is in the off-state when the two partial switches are in the off-state. In order to avoid a short circuit between two of the input nodes a, b, c it is desirable to adjust a timing of switching on and switching off the electronic switches 2a, 2b, 2c (or 21a-21c, 22a-22c) such that the switches in two different half-bridges 1a, 1b, 1c are not in the on-state at the same time. Thus, according to one example, the control circuit 6 is configured to control operation of the electronic switches 2a, 2b, 2c (or 21a-21c, 22a-22c) in the half-bridges 1a, 1b, 1c such that there is a delay time between the end of operating the at least one electronic switch in one of the half-bridges in the on-state and the beginning of operating the at least one electronic switch in another one of the half-bridges in the on-state.

However, it is not desirable to interrupt a current flow from the input a, b, c to the output m, n during this dead time. Otherwise, inductances in the switching circuit 1 and in the circuit connected to the output m, n of the switching circuit 1 may cause undesirable high voltage peaks. Such inductances may include a transformer 40 as illustrated in FIGS. 17 and 18 or an inductance 432 of a resonant circuit as illustrated in FIG. 18. But even (parasitic) line inductances may be sufficient to generate such undesirable high voltage peaks.

In the following, “dead time” and transition phase denotes the time period between the end of the on-state off the at least one electronic switch in one off the half-bridges 1a, 1b, 1c and the beginning of the on-state of the at least one electronic switch in another one of the half-bridges. Furthermore, for the purpose of explanation it is assumed that each half-bridge 1a, 1b, 1c includes only one electronic switch 2a, 2b, 2c. Everything explained in the following with regard to half-bridges including one electronic switch 2a, 2b, 2c applies to half-bridges with two electronic switches accordingly, wherein the two electronic switches are operated synchronously in the same way as the one electronic switch 2a, 2b, 2c.

In order to avoid the input current Im at the output m, n of the switching circuit 1 from being interrupted during the dead time, the control circuit 6, according to one example, is configured to operate the electronic switches 2a, 2b, 2c in transition states during the dead time. As used herein, a transition state of a bidirectionally blocking electronic switch is an operating state in which the electronic switch is in a unidirectionally blocking state and, accordingly, unidirectionally conducting state.

Each bidirectionally blocking switch can be operated in a first transition state, in which the electronic switch is configured to conduct a current flowing in a first direction, and a second transition state, in which the electronic switch is configured to conduct a current flowing in a second direction opposite the first direction. Operating a bidirectionally blocking switch in the first transition state includes operating one of the two partial switches in the on-state and the other one of the two partial switches in the off-state. Operating the bidirectionally blocking switching the second transition state includes operating the one of the two partial switches in the off-state and operating the other one of the two partial switches in the on-state.

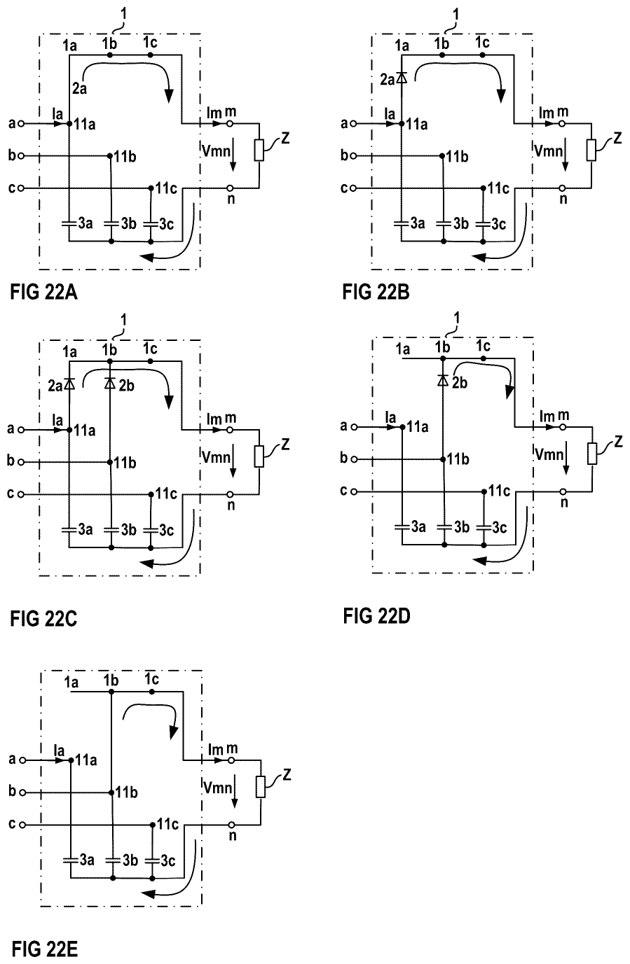

Operating bidirectionally blocking switches in two different half bridges during the transition phase is explained with reference to FIGS. 22A-22E in the following. For the purpose of illustration, FIGS. 22A-22E illustrate a transition of the switching circuit 1 from an on-state of the electronic switch to 2a in the first half-bridge 1a to the on-state of the electronic switch 2b in the second half-bridge 1b. This, however, is only an example. The example illustrated in FIGS. 22A-22E applies to transitions between the on-states in each pair of the half-bridges 1a, 1b, 1c accordingly. The load Z illustrated in FIGS. 22A-22E illustrates any type of electronic circuit explained herein before that may be connected to the output nodes m, n of the switching circuit 1.

FIG. 22A illustrates an operating state of the switching circuit 1, in which the electronic switch 2a in the first half-bridge 1a is in the on-state. The on-state of the electronic switch 2a is represented by a solid line in FIG. 22A. The electronic switches 2b, 2c in the other two half-bridges 1b, 1c are in the off-state, which is illustrated by an interrupted connection between the respective switched nodes 11b, 11c and the first output node m.

For the purpose of illustration it is assumed that the input current Ia received at the first input node and, equivalently, the current Im at the output m, n of the switching circuit 1 a flows in a first current direction when the electronic switch 2a is in the on-state.

Referring to FIG. 22B, the transition from the on-state of the electronic switch 2a in the first half-bridge to the on-state of the electronic switch 2b in the second half-bridge 1b includes operating the electronic switch 2a in the first half-bridge 1a in a first transition state, which is a unidirectionally conducting state that allows the input current 1a to further flow in the first direction. The first transition state of the electronic switch 2a is represented by the freewheeling element (diode) of that one of the two partial switches of the bidirectionally blocking switch 2a, that is in the off-state in the first transition state.

Referring to FIG. 22C, the transition further includes operating the electronic switch 2b in the second half-bridge 1b, in the first transition state, which is an operating state that allows a current Ib received at the second input b to flow in the first direction, which is a direction from the switched node 11b to the first output m. As both electronic switches 2a, 2b are in the same transition state, a short circuit between the first and second input nodes a, b is prevented.

Referring to FIG. 22D, the transition phase further includes switching off the electronic switch 2a and the first half-bridge 1a. After switching off the electronic switch 2a in the first half-bridge 1a, the electronic switch 2b in the second half-bridge 1b may take over the current provided by the switching circuit 1 to the load Z. It should be noted that the voltage is received at the first and second inputs a, b may have different polarities. Nevertheless, after the on-state of the electronic switch 2a in the first half-bridge 1a, the output current Im may maintain its current direction for a certain time period before the current direction changes during the on-state of the electronic switch 2b in the second half-bridge 1b. Thus, during the transition phase the two electronic switches 2a, 2b are to be operated in the same first or second transition state.

Referring to FIG. 22E, at the end of the transition phase the electronic switch 2b is operated in the on-state, as illustrated in FIG. 22E.

Referring to the above, FIGS. 22A-22E illustrate a transition between on-state of electronic switches in two different half-bridges when the current flowing through the electronic switch that is to be switched off flows in the first direction. As explained above, the transition phase in this example includes subsequently operating the two electronic switches in the first transition state. In the example, in which the current flows in the opposite direction, the two electronic switches are subsequently operated in the second transition state.

Some of the aspects explained above are briefly summarized in the following with reference to numbered examples.

Example 1. A method, including: generating an alternating voltage based on three alternating input voltages received at an input of a power converter, wherein generating the alternating voltage includes: generating the alternating voltage in an unregulated fashion by a switching circuit including a three-phase half-bridge, controlling a waveform of the alternating voltage dependent on signal levels of the input voltages, and controlling a power factor of power received at the input.

Example 3. The method of example 2, wherein controlling the waveform of the alternating voltage and controlling the power factor includes: detecting a highest input voltage, a second highest input voltage, and a lowest input voltage of the three input voltages; and generating the alternating voltage such that in each period a voltage level of the alternating voltage at least approximately equals the voltage level of the highest input voltage for a first time period, the voltage level of the second highest input voltage for a second time period, and the voltage level of the lowest input voltage for a third time period.

Example 3. The method according to example 2, wherein an overall duration of each period of the alternating voltages is at least approximately fixed.

Example 4. The method according to example 2 or 3, wherein a duration of the first time period is at least approximately fixed.

Example 5. The method according to example 4, wherein the duration of the first time period at least approximately equals 50% of the overall duration.

Example 6. The method according to any one of examples 2 to 5, wherein a duration of the second time period is dependent on a relationship between a magnitude of the second highest input voltage and a magnitude of the second highest input voltage.

Example 7. The method according to any one of examples 2 to 6, wherein the duration of the second time period is further dependent on a relationship between a magnitude of a second current and a first current, wherein the first current is the current received at that one of the three inputs receiving the highest input voltage, and wherein the second current is the current received at that one of the three inputs receiving the second highest input voltage.

Example 8. The method according to any one of examples 1 to 7, further including: generating a rectified output voltage based on the alternating voltage at an output of the power converter.

Example 9. The method according to example 8, wherein the output is galvanically isolated from input.

Example 10. The method according to any one of examples 1 to 9, wherein the switching circuit includes three half-bridges each including at least one electronic switch, a capacitor connected in series with the at least one electronic switch, and a switched node between the capacitor and the at least one electronic switch, wherein the input voltages, in each period of the input voltages, include a plurality of unique states, and wherein, in each of the unique states, the electronic switches of the switching circuit are operated in accordance with a predefined switching pattern.

Example 11. A power converter, including: a switching circuit; and a control circuit, wherein the switching circuit includes a three-phase half-bridge, is configured to receive three alternating input voltages from an input of the power converter, and includes an output, and wherein the control circuit is configured to control operation of the switching circuit such that the switching circuit generates an alternating voltage based on the alternating input voltages in an unregulated fashion, controls a waveform of the alternating voltage dependent on signal levels of the input voltages, and controls a power factor of power received at the input.

Example 12. The power converter of example 11, wherein the switching circuit includes three half-bridges each including at least one electronic switch, a capacitor connected in series with the at least one electronic switch, and a switched node between the capacitor and the at least one electronic switch, wherein the switched node of each of the three half-bridges is coupled to a respective one of the three input, and wherein the series circuit with the least one electronic switch and the capacitor of each of the three half-bridges is connected between a first output node and a second output node of the output of the switching circuit.

Example 13. The power converter of example 12, wherein the at least one electronic switch in each of the three half-bridges is a bidirectionally blocking electronic switch.

Example 14. The power converter of any one of examples 11 to 13, further including: a rectifier circuit coupled to the output of the switching circuit.

Example 15. The power converter of example 14, further including: a transmitter including a transformer coupled between the output of the switching circuit and the rectifier circuit.

1. A method comprising:
generating an alternating output voltage based on three alternating input voltages received at input nodes of a power converter;
wherein generating the alternating output voltage comprises:
generating the alternating output voltage in an unregulated manner via a switching circuit comprising a three-phase half-bridge;
controlling generation of the alternating output voltage dependent on magnitudes of the three alternating input voltages, and
controlling a power factor of power received at the input nodes of the power converter.

2. The method according to claim 1,
wherein controlling the generation of the alternating output voltage and controlling the power factor comprises:
detecting a highest input voltage, a second highest input voltage, and a lowest input voltage of the three input voltages; and
generating the alternating output voltage such that in each period a voltage level of the alternating output voltage at least approximately equals
the voltage level of the highest input voltage for a first time period,
the voltage level of the second highest input voltage for a second time period, and
the voltage level of the lowest input voltage for a third time period.

3. The method according to claim 2,
wherein an overall duration of each period of the alternating output voltages is at least approximately fixed.

4. The method according to claim 3,
wherein a duration of the first time period is at least approximately fixed.

5. The method according to claim 4,
wherein the duration of the first time period at least approximately equals 50% of the overall duration.

6. The method according to claim 5,
wherein a duration of the second time period is dependent on a relationship between a magnitude of the second highest input voltage and a magnitude of the highest input voltage.

7. The method according to claim 6,
wherein the duration of the second time period is further dependent on a relationship between a magnitude of a second current and a first current,
wherein the first current is the current received at that one of the three inputs receiving the highest input voltage, and
wherein the second current is the current received at that one of the three inputs receiving the second highest input voltage.

8. The method according to claim 1, further comprising:
generating a rectified output voltage based on the alternating output voltage at an output of the power converter.

9. The method according to claim 8,
wherein the output is galvanically isolated from input.

10. The method according to claim 1,
wherein the switching circuit comprises three half-bridges each comprising at least one electronic switch, a capacitor connected in series with the at least one electronic switch, and a switched node between the capacitor and the at least one electronic switch,
wherein the input voltages, in each period of the input voltages, include a plurality of unique states, and
wherein, in each of the unique states, the electronic switches of the switching circuit are operated in accordance with a predefined switching pattern.

11. A power converter, comprising:
a switching circuit; and
a control circuit,
wherein the switching circuit includes a three-phase half-bridge, which is configured to receive three alternating input voltages from an input of the power converter, and includes an output, and
wherein the control circuit is configured to control operation of the switching circuit such that the switching circuit
generates an alternating output voltage based on the alternating input voltages in an unregulated fashion,
controls a waveform of the alternating output voltage dependent on magnitudes of the input voltages, and
controls a power factor of power received at the input.

12. The power converter of claim 11,
wherein the switching circuit comprises three half-bridges each comprising at least one electronic switch, a capacitor connected in series with the at least one electronic switch, and a switched node between the capacitor and the at least one electronic switch,
wherein the switched node of each of the three half-bridges is coupled to a respective one of the three input, and
wherein the series circuit with the least one electronic switch and the capacitor of each of the three half-bridges is connected between a first output node and a second output node of the output of the switching circuit.

13. The power converter of claim 12,
wherein the at least one electronic switch in each of the three half-bridges is a bidirectionally blocking electronic switch.

14. The power converter of claim 13, further comprising:
a rectifier circuit coupled to the output of the switching circuit.

15. The power converter of claim 14, further comprising:
a transmitter comprising a transformer coupled between the output of the switching circuit and the rectifier circuit.

16. A method comprising:
receiving multiple alternating input voltages at input nodes of a power converter;
via a switching circuit of the power converter, generating an alternating output voltage dependent on magnitudes of the multiple alternating input voltages, the generated alternating output voltage being unregulated;
controlling a power factor of power received at the input nodes of the power converter during the generation of the alternating output voltage.
